(19) United States
(12) Patent Application Publication
(10) Pub. No.: US 2023/0092727 A1
(43) Pub. Date: Mar. 23, 2023

(54) COMPLEXING AGENT CONTENT DETERMINATION METHODS

(71) Applicant: THE BOEING COMPANY, Chicago, IL (US)

(72) Inventors: Edgardo A. REYES BRONDO, Madison, AL (US); Tammy L. Moore, Huntsville, AL (US)

(21) Appl. No.: 17/476,523

(22) Filed: Sep. 16, 2021

(51) Int. Cl. G01N 31/22; C09B 29/01; C25D 5/38; C25D 3/12; G01N 21/78

(52) U.S. Cl. CPC G01N 31/22; C09B 29/0003; C25D 5/38; C25D 3/12; G01N 21/78

(57) ABSTRACT

Aspects of the present disclosure relate to methods of complexing agent content determination. In at least one aspect, a method includes diluting a first solution with water to form a second solution. The first solution includes a nickel source and a complexing agent. The method includes introducing an indicator with the second solution. The method includes titrating the second solution with a base to provide a color change of the second solution. The method includes calculating a content of the complexing agent of the first solution.

### FIELD

Aspects of the present disclosure relate to methods of complexing agent content determination.

### BACKGROUND

Titanium substrates are plated with metallic materials for various reasons. For example, mechanical fasteners are used for joining the structural components of an aerospace vehicle, such as an airframe of an aircraft. Such mechanical fasteners are often fabricated from titanium alloys due to the desirable light weight and corrosion resistant qualities of titanium. However, titanium alloys can have less than ideal wear resistance and can be galvanically incompatible with aluminum alloys that are used for major fuselage and wing structure applications.

Many of the drawbacks of titanium alloys can be addressed by plating. However, metallic plating on titanium substrates is often complicated by the extremely stable oxide formation on the surface of the titanium substrate, and also by the fact that very few chemical etchants are capable of attacking the oxide formation. Methods for removing a protective oxide layer on the substrate before electroplating the metallic material can be used. Such methods can include use of an activation solution containing nickel and a complexing agent. For example, in the case of nickel sulfate and citric acid, there is a huge need for surface finishes to use nickel baths, e.g., for cars and appliances.

During such processes on an industrial scale, the amount of complexing agent should be monitored to ensure whether or not the amount of complexing agent is being depleted during use. For solutions generally, indicators can be used in solutions/formulations to indicate presence, absence, concentration of a substance, and/or pH of the solution by change in color under various conditions. For example, phenolphthalein is used for testing pH of a solution (e.g., neutral and below pH of 8.2 (acid) is colorless, and at pH of 8.3 or greater (alkaline) is pink). However, activation solutions containing nickel typically have a dark green coloration, and indicators such as phenolphthalein cannot be used. For example, citric acid concentration determination of a nickel-containing solution via titration with phenolphthalein poses a challenge due to the inability to see the color change endpoint of the titrated sample. In addition, if there are impurities or other additives that provide color to a solution, then phenolphthalein cannot provide an accurate endpoint.

Alternatively, chromatographic methods can be used to determine complexing agent content, such as High Performance Liquid Chromatography or Gas Chromatography. However, such chromatographic methods are drastically more expensive and time consuming than a simple titration with phenolphthalein, making the viability of chromatographic methods difficult for use with an industrial scale manufacturing process.

There is a need for new methods of determining complexing agent content (e.g., weak acids) in colored activation solutions.

### SUMMARY

Aspects of the present disclosure relate to methods of complexing agent content determination.

In at least one aspect, a method includes diluting a first solution with water to form a second solution. The first solution includes a nickel source and a complexing agent. The method includes introducing an indicator with the second solution. The method includes titrating the second solution with a base to provide a color change of the second solution. The method includes calculating a content of the complexing agent of the first solution.

In at least one aspect, a method includes introducing an indicator with a first solution. The first solution includes a nickel source and a complexing agent. The method includes diluting with water the first solution comprising the indicator to form a second solution. The method includes titrating the second solution with a base to provide a color change of the second solution. The method includes calculating a content of the complexing agent of the first solution.

### BRIEF DESCRIPTION OF THE FIGURES

To assist those of ordinary skill in the relevant art in making and using the subject matter hereof, reference is made to the appended figures.

FIG. 1A is a flow diagram of a method, according to an aspect.

FIG. 1B is a flow diagram of a method, according to an aspect.

FIG. 2 is a flow diagram of a method for plating a metallic material onto a titanium substrate, according to an aspect.

FIG. 3 is a schematic illustration of a titanium substrate having an outer surface and an oxide layer on the outer surface, according to an aspect.

FIG. 4 is a schematic illustration of a plated structure manufactured in accordance with the method for plating depicted in FIG. 1, according to an aspect.

FIG. 5 is a flow diagram depicting an example method for etching the outer surface of a titanium substrate in accordance with the method for plating depicted in FIG. 2, according to an aspect.

FIG. 6 is a schematic illustration of a system for activating a titanium substrate in accordance with the method for plating depicted in FIG. 2, according to an aspect.

FIG. 7 is a schematic illustration of an electrochemical cell for establishing an anodic etching current in accordance with the method for plating depicted in FIG. 2, according to an aspect.

FIG. 8 is a flow diagram depicting an example method for establishing a cathodic protection current through a titanium substrate in accordance with the method for plating depicted in FIG. 2, according to an aspect.

FIG. 9 is a schematic illustration of an electrochemical cell for establishing a cathodic protection current in accordance with the method for plating depicted in FIG. 2, according to an aspect.

FIG. 10 is another flow diagram depicting an example of the disclosed method for plating a metallic material onto a titanium substrate, according to an aspect.

FIG. 11 is yet another flow diagram depicting an example of the disclosed method for plating a metallic material onto a titanium substrate, according to an aspect.

FIG. 12 is a cross-sectional view of an article, particularly a mechanical fastener (e.g., a bolt), manufactured in accordance with the method of FIG. 2, according to an aspect.

FIG. 13 is a cross-sectional view of a portion of the article shown in FIG. 12, according to an aspect.

FIG. 14 is a flow diagram of a method of manufacturing an aircraft, according to an aspect.

FIG. 15 is a block diagram of an aircraft, according to an aspect.

### DETAILED DESCRIPTION

Aspects of the present disclosure relate to methods of complexing agent content determination. For example, a complexing agent content can be a concentration or amount of complexing agent in a nickel-containing solution. In some aspects, methods may include methods for determining citric acid content (e.g., amount or concentration) in nickel-containing solutions.

Methods may further include plating a metallic material onto a substrate and removing a protective oxide layer on the substrate before electroplating the metallic material onto the substrate.

Methods of the present disclosure provide determination of complexing agent content (e.g., weak acids or other acids) in colored activation solutions without a need for expensive, time consuming chromatographic methods (e.g., chromatographic methods are merely optional).

### Methods of Complexing Agent Determination

During industrial use of a solution including a nickel source and a complexing agent, nickel may deposit onto a substrate and it may be desirable to determine whether or not the amount of complexing agent is being depleted over time during use.

Methods of the present disclosure include providing a solution including a nickel source and a complexing agent. The solution can have a pH of about 2 to about 5, such as about 3.5 to about 4.

In some aspects, a method includes diluting the solution with water to form a diluted solution and introducing an indicator to the diluted solution. Alternatively, a method includes introducing an indicator to the solution followed by diluting the solution with water to form a diluted solution.

In some aspects, a method further includes titrating the diluted solution with a basic solution to provide a color change of the diluted solution provided by the indicator.

The solution including the nickel source and the complexing agent can be diluted with water by a factor of about 2 to about 50, such as about 15 to about 25. For example, a 2.5 mL solution including the nickel source and the complexing agent can be diluted with about 50 mL water to form the diluted solution. For solutions used in industrial scale processes, use of a small amount of the solution (e.g., 2.5 mL) and an indicator with titration provides a convenient, fast, and inexpensive monitoring of complexing agent content of the solutions. In addition, small amounts of indicator (e.g., a few drops) can be used with the small amounts of the solution (e.g., 2.5 mL).

A nickel source can be any suitable nickel source of a nickel cation. In some aspects, a nickel source is a nickel sulfate, a nickel acetate, a nickel chloride, or combination(s) thereof.

A complexing agent can be any suitable complexing agent, such as an acid. In some aspects, an acid is a citric acid, an ascorbic acid, an oxalic acid, a bisulfite.

An indicator can be any suitable indicator.

In some aspects, an indicator is represented by the formula:

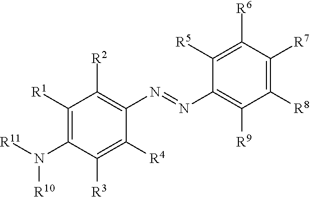

wherein:
each of R¹, R², R³, R⁴, R⁵, R⁶, R⁷, R⁸, and R⁹ is independently selected from the group consisting of hydrogen, alkyl, —SO₃H, and —CO₂H; and
each of R¹⁰ and R¹¹ is independently selected from the group consisting of hydrogen and alkyl.

In some aspects, at least one of R⁵, R⁶, R⁷, R⁸, and R⁹ is —SO₃H or —CO₂H.

In some aspects, an indicator is methyl red, methyl orange, or combination(s) thereof. Methyl Red ((C₁₅H₁₅N₃O₂) 2,2-[4-(Dimethylamino)phenylazo]benzoic acid) is a colorant that is red at pH<4.4, yellow at pH>6.2, and orange between pH 4.4 and 6.2. Methyl orange ((C₁₄H₁₅N₃SO₃) 4-{[4-(dimethylamino)phenyl]diazenyl}benzene-1-sulfonic acid) is a colorant that is red at pH<3.1, yellow at pH>4.4, and orange between pH 3.1 and 4.4.

A basic solution can be any suitable basic solution. For example, a basic solution can include a base such as a hydroxide base (e.g., sodium hydroxide, potassium hydroxide, barium hydroxide, calcium hydroxide, or combination(s) thereof). A basic solution can have a concentration of about 0.01 M to about 1 M, about 0.1 M to about 1.0 M, alternatively such as about 0.05 M to about 0.15 M, such as about 0.1 M.

The diluted solution is titrated with the basic solution until a color change is observed or an endpoint is otherwise determined. In general, unless pH based titration indicators change colors, the interaction between the titrant and the indicator is undeterminable. However, with use of methyl red or methyl orange in a nickel-containing solution, the indicator can turn the green nickel-containing diluted solution to a pink color and upon titration with a basic solution turns the diluted solution to yellow (followed by clear and back to green). The return of the color of the solution back to green can be deemed the endpoint of the titration, as the green indicates that the complexing agent has been consumed and methyl red is transparent in alkali medium, hence the solution turns back to green due to presence of nickel.

Methods can include calculating a content of complexing agent in the solution. For example, a content of complexing agent (e.g., g/L of complexing agent) in the solution (before the dilution with water) can be determined using Equation 1:

$$ml of basic solution \times ( \frac{\# mol base}{1 L Solution} ) \times ( \frac{\# mol complexing agent}{\# mol base} ) \times ( \frac{1}{\# mL solution} ) \times ( \frac{g}{mol} complexing agent ) = g / L of complexing agent \qquad ( Eq . 1 )$$

For example, if citric acid is used as a complexing agent and 0.1 M NaOH is used as a basic solution, a content of citric acid (g/L) in a 2.5 mL solution (before the dilution with water) can be determined using Equation 2:

$$ml of NaOH 0.1 M \times ( \frac{0.1 mol NaOH}{1 L Solution} ) \times ( \frac{1 Mol Citric Acid}{3 Mol NaOH} ) \times ( \frac{1}{2.5 mL Sample Size} ) \times ( \frac{192 g Citric}{1 Mol Citric} ) = g / L of Citric Acid \qquad ( Eq . 2 )$$

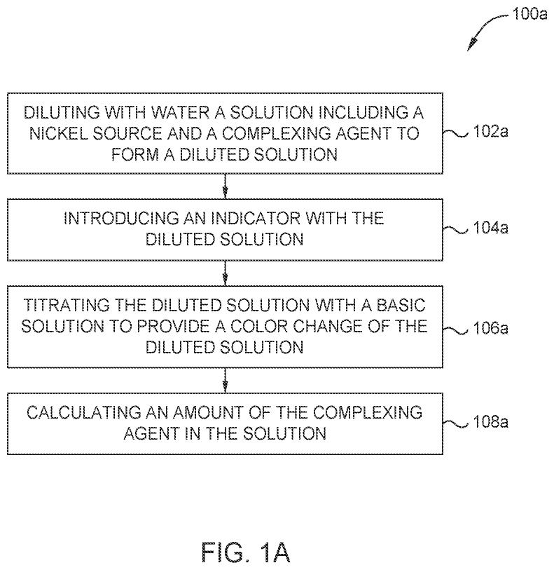

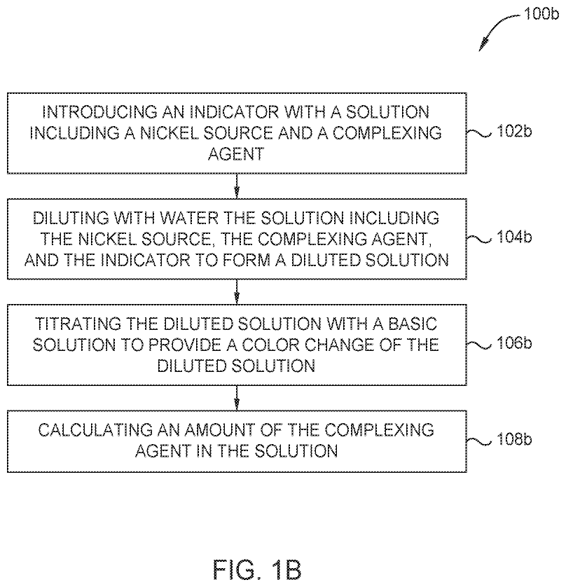

FIG. 1A is a flow diagram illustrating a method 100a of complexing agent content determination, according to at least one aspect. Method 100a includes diluting 102a with water a solution including a nickel source and a complexing agent to form a diluted solution. The water can be water only (e.g., substantially pure water) or can be an aqueous solution including other components or impurities. In some aspects, the water is substantially pure water (e.g., greater than 99.9 wt % water). Method 100a includes introducing 104a an indicator with the diluted solution. Method 100a includes titrating 106a the diluted solution with a basic solution to provide a color change of the diluted solution. Method 100a includes calculating 108a a content of the complexing agent in the solution (e.g., the solution before the solution was diluted with the water and/or before the indicator was introducing with the solution).

FIG. 1B is a flow diagram illustrating a method 100b of complexing agent content determination, according to at least one aspect. Method 100b includes introducing 102b an indicator with a solution including a nickel source and a complexing agent. Method 100b includes diluting with water the solution including the nickel source, the complexing agent, and the indicator to form a diluted solution. The water can be water only (e.g., substantially pure water) or can be an aqueous solution including other components or impurities. In some aspects, the water is substantially pure water (e.g., greater than 99.9 wt % water). Method 100b includes titrating 106b the diluted solution with a basic solution to provide a color change of the diluted solution. Method 100b includes calculating 108b a content of the complexing agent in the solution (e.g., the solution before the solution was diluted with the water and/or before the indicator was introducing with the solution).

### Non-Limiting Example Method(s) of Manufacturing and Complexing Agent Content Determination

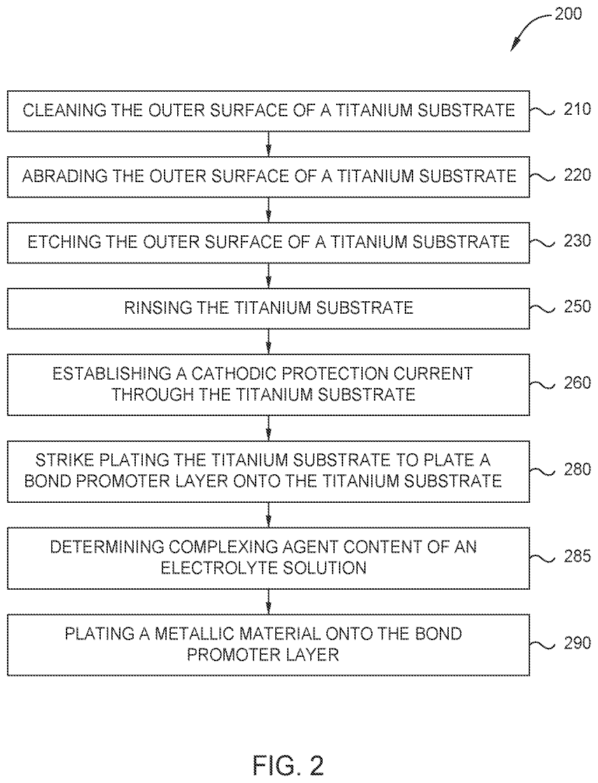

Referring to FIGS. 2-4, the present disclosure provides examples of a method 200 for plating a metallic material 18 onto a titanium substrate 10 that includes an outer surface 12 and an oxide layer 14 on the outer surface 12. In performing the method 200, at least a portion of the oxide layer 14 may be removed so that the metallic material 18 may then be plated onto an etched titanium substrate 11 (FIG. 4). Further, an intermediate bond promoter layer 16 may be provided between the etched titanium substrate 11 and the metallic material 18 to promote plating adherence. As such, the resulting plated structure 20 may retain the desirable qualities of titanium (e.g., lightweight and corrosion-resistant) while also possessing the bonding and grounding attributes of the metallic material 18.

The method 200 includes etching (block 230) the outer surface 12 of the titanium substrate 10 and, at block 160, establishing a cathodic protection current through the titanium substrate 10 that has been etched. Blocks 230 and 260 may be performed to remove the oxide layer 14 on the outer surface 13 of the etched titanium substrate 11. Following oxide layer removal, the method 200 further includes, at block 280, strike plating the titanium substrate to plate a bond promoter layer 16 onto the titanium substrate 10 and, at block 290, plating a metallic material 18 onto the bond promoter layer 16.

The method 200 may be performed on any suitable titanium substrate 10 regardless of size, shape and function. In one example, the titanium substrate 10 may be a commercially available one-sided lockbolt mechanical fastener. By performing the method 200 on the mechanical fastener, the plated mechanical fastener may exhibit improved bonding and grounding capabilities. In another example, the titanium substrate 10 may be a custom-machined portion of a fuselage, which may be plated on for similar reasons.

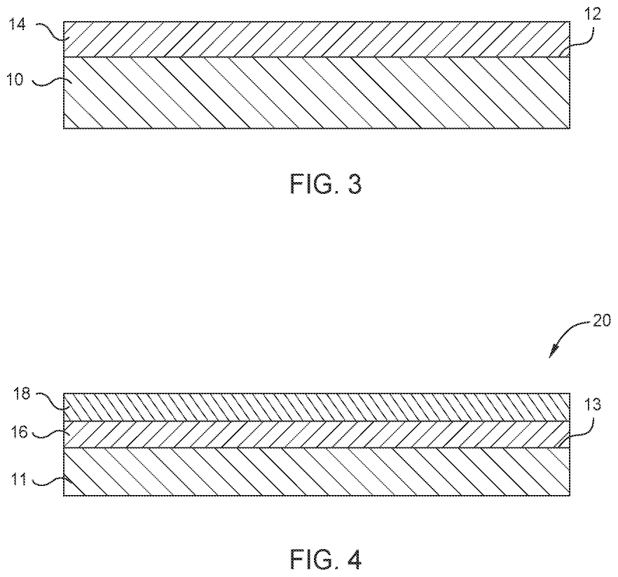

The material composition of the titanium substrate 10 may include pure titanium, any suitable titanium alloy and any combination thereof. One suitable titanium material may include, for example, Ti-6Al-4V. Further, the titanium substrate 10 may be homogenous in its composition or contain discrete regions of different titanium materials. For example, the titanium substrate 10 shown in FIGS. 3, 4, 6, 7 and 9 may be formed from a titanium alloy (e.g., Ti-6Al-4V). Those skilled in the art will appreciate that the suitability of any particular titanium alloy may be based, at least in part, on the compatibility of that titanium alloy with the bond promoter layer 16 to be strike plated.

Often, the outer surface 12 of a titanium substrate 10 may contain debris (e.g., foreign contaminants). This debris obstructs access to the oxide layer 14 and, if not removed, may hinder efforts to remove the oxide layer 14. Accordingly, the method 200 may begin at block 210 with cleaning the outer surface 12 of a titanium substrate 10 to remove debris (if any). In an example, the cleaning (block 210) may be performed by wiping the outer surface 12 of the titanium substrate 10 with a solvent wipe. In an example, the cleaning (block 210) may be performed by exposing the outer surface 12 to an organic solvent. In an example, the cleaning (block 210) may be performed by blasting the outer surface 12 with a dry abrasive. In an example, the cleaning (block 210) may be performed by vibratory finishing. In an example, the cleaning (block 210) may be performed by barrel tumbling.

The method 200 may include, at block 220, abrading (e.g., roughening) the outer surface 12 of a titanium substrate 10. In doing so, the abrading (block 220) may mechanically remove at least a portion of the oxide layer 14, if not most of it. Those skilled in the art will appreciate that abrading (block 220) the outer surface 12 of the titanium substrate 10 may also increase the overall surface area of the outer surface 12, thereby increasing the dissolvability of the oxide layer 14.

A suitable abrasion method may be determined based on, among other things, the number of titanium substrates 10 to be abraded. In one example, batches of titanium substrates 10 may be abraded in a tumbler. Of course, this abrasion method may be preferred for applications involving large numbers of titanium substrates 10. For applications involving fewer titanium substrates 10, blasting the titanium substrates 10 with an abrasive medium may be adequate. In these examples, the blasting may be performed using either wet or dry abrasive mediums, and abrasive mediums of varying grit sizes. In one example, the abrading (block 220) may include blasting the titanium substrate 10 with an abrasive medium having a grit size of at least about 60 microns. In another example, the abrading (block 220) may include blasting the titanium substrate 10 with an abrasive medium having a grit size of at least about 100 microns. In yet another example, the abrading (block 220) may include blasting the titanium substrate 10 with an abrasive medium having a grit size of at least about 140 microns.

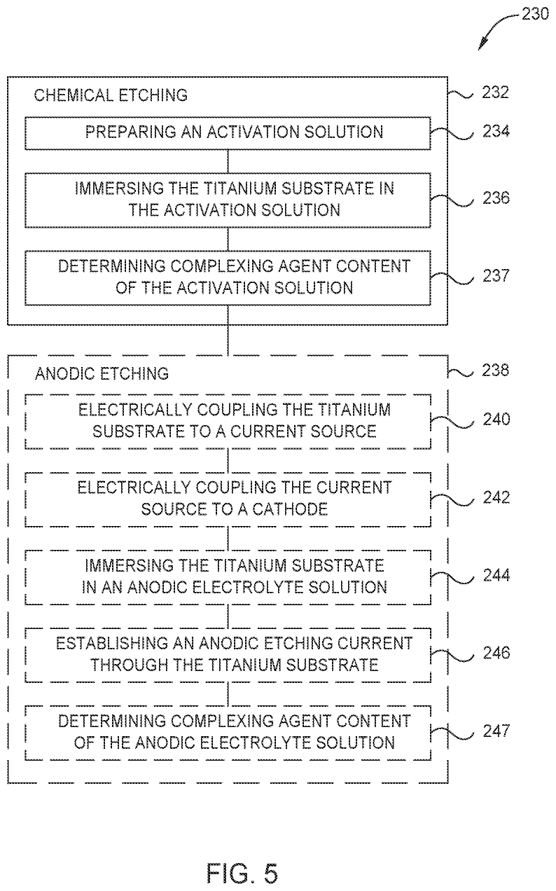

Referring to FIG. 5, the method 200 includes, at block 230, etching the outer surface 12 of a titanium substrate 10 to remove at least a portion of the oxide layer 14, thereby yielding an etched titanium substrate 11. Like the abrading (block 220), the etching (block 230) may be performed to reduce the oxide layer 14 in preparation for subsequent plating (block 290).

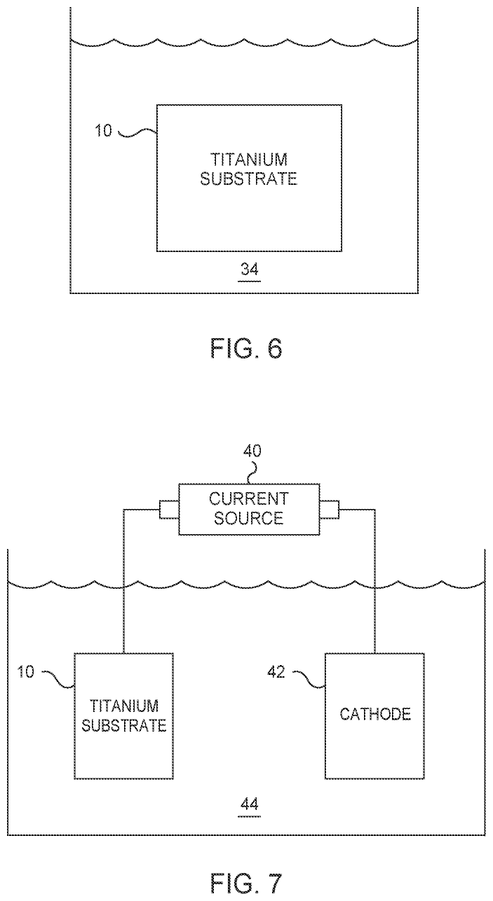

Referring to FIG. 6, the etching (block 230) may be performed by chemical etching (block 232) the outer surface 12 of the titanium substrate 10. For example, a suitable activation solution 34 may be prepared (block 234 (“preparing an activation solution”)) and the titanium substrate may be immersed (block 236 (“immersing the titanium substrate in the activation solution”)) in the activation solution for a predetermined duration of time or until a desired amount of oxide layer 14 has been removed. A reason for the etching is to remove the top 0.5-5 micron layer on the surface that is disturbed material and slightly embedded grit (called the Bielby layer) which might otherwise provide less than ideal plating adhesion.

While any suitable oxide removal mechanism may be employed, it is generally contemplated that the activation solution 34 should include an oxide removal agent and a complexing agent. The oxide removal agent may remove oxygen ions from the oxide layer 14, thereby dissolving the oxide layer 14, and the complexing agent may complex with the oxygen ions in solution (e.g., oxygen scavenging) to prevent the oxide layer 14 from reforming.

The oxide removal agent may be fluoride-based (e.g., contains fluoride ions) and may be added to the activation solution 34 as a fluoride salt. For example, the activation solution 34 may include from about 2 grams to about 8 grams of sodium fluoride per liter of activation solution 34. In another example, the activation solution 34 may include from about 4 grams to about 6 grams of sodium fluoride per liter of activation solution 34.

Any suitable complexing agent (or complexing agents) may be employed to scavenge for oxygen ions in the activation solution 34. For example, acids, such as ascorbic acid, oxalic acid, and bisulfite, can be used. It is generally contemplated, however, that the suitability of a complexing agent may be determined, at least in part, on the compatibility of the complexing agent with the oxide removal agent, and possibly other activation solution components as well (if included). The complexing agent should not interfere/hinder those associated mechanisms (e.g., oxide removal, etc.). One such type of a suitable complexing agent may include, for example, citric acid, or other organic acids. In one example, the activation solution 34 may include at least about 30 grams of citric acid per liter of activation solution 34. In another example, the activation solution 34 may include at least about 50 grams of citric acid per liter of activation solution 34. In another example, the activation solution 34 may include at least about 70 grams of citric acid per liter of activation solution 34. In another example, the activation solution 34 may include about 30 to about 80 grams of citric acid per liter of activation solution 34.

In addition to the oxide removal agent and the complexing agent, in one or more examples, the activation solution 34 may also include a non-oxidizing acid. Those skilled in the art will appreciate that non-oxidizing acids are less likely than oxidizing acids to oxidize the titanium substrate 10, and may be included to help keep the pH of the activation solution 34 relatively low (e.g., pH less than 5). Without being bound by any particular theory, it is believed that by keeping the pH of the activation solution 34 relatively low, the available concentration of hydroxide ions in solution may be suppressed providing an environment for oxide removal. However, it is also generally contemplated that the pH of the activation solution 34 need not be overly acidic (e.g., pH less than 3) or immersed for too long due to the potential of hydrogen ingress into the titanium substrate 10 (e.g., hydrogen embrittlement).

In one example, the non-oxidizing acid may include sulfuric acid. More specifically, the activation solution 34 may include sulfuric acid at concentrations dilute enough such that the reduction of sulfate to SO₂ (which is oxidizing) does not occur. For example, the activation solution 34 may include at least about 50 grams of sulfuric acid per liter of activation solution 34, such as about 50 to about 150 grams of sulfuric acid per liter of activation solution 34. In another example, the activation solution 34 may include at least about 90 grams of sulfuric acid per liter of activation solution 34. In yet another example, the activation solution 34 may include at least about 130 grams of sulfuric acid per liter of activation solution 34.

In other examples, the non-oxidizing acid may include phosphoric acid, phosphorous acid, fluoboric acid, or fluosilicic acid if the acid and fluoride sources are combined.

As shown in FIG. 5, method 230 can further include determining 237 the complexing agent content of activation solution 34, e.g., after immersing the titanium substrate in the activation solution 34.

Also shown in FIG. 5, the etching (block 230) may also include anodic etching (block 238) the titanium substrate 10 to further remove the oxide layer 14. As shown in FIG. 7, the anodic etching (block 238) may be performed in a standard two-electrode bath, where the titanium substrate 10 (e.g., the anode) and a suitable cathode 42 is electrically coupled (blocks 240 (“electrically coupling the titanium substrate to a current source”) and 242 (“electrically coupling the current source to a cathode”)) to a current source 40, and immersed (block 244 (“immersing the titanium substrate in an anodic electrolyte solution”)) in an anodic electrolyte solution 44. By establishing an anodic etching current through the titanium substrate 10, as shown in block 246, a reduction reaction may occur on the outer surface 12 of the titanium substrate 10, thereby causing the removal of surface-level titanium (e.g., etching). In doing so, at least a portion of the oxide layer 14 may be removed as well. The application of anodic current means hydrogen evolution occurs on the cathode and away from the part.

In one or more examples, the anodic etching (block 238) may be performed simultaneously with the chemical etching (block 232). More specifically, blocks 240-246 may be performed while the titanium substrate 10 is immersed in an activation solution 34. The activation solution 34 may be formulated to contain charge-carrying electrolytes, thereby completing the electrochemical cell (meaning that a separate anodic electrolyte solution is not needed). Without being bound by any particular theory, it is believed that by performing blocks 232 and 238 simultaneously, the anodic etching (block 238) may provide the use of activation solutions 34 at lower temperatures because the anodic etching (block 238) compensates for the diminished capability of the activation solution 34 to remove the oxide layer.

A suitable activation solution 34 for performing blocks 232 and 238 (independently or simultaneously) may include an oxide removal agent, a complexing agent, and a non-oxidizing acid. The oxide removal agent may be, for example, sodium fluoride at about 2 grams to about 8 grams per liter of activation solution 34. The complexing agent may be, for example, citric acid at no less than about 30 grams per liter of activation solution 34 (e.g., about 30 to about 80 grams of citric acid per liter of activation solution 34. The non-oxidizing acid may be, for example, sulfuric acid at no less than about 50 grams per liter of activation solution 34, such as from about 50 to about 150 grams per liter of activation solution 34. Alternatively, some commercially available solutions may be suitable as well, such as Dipsol 602-AS Power Acid available from Dipsol of America, Inc. of Livonia, Mich.

Depending on the size and shape of the titanium substrate 10, the current density of the anodic etching current may be adjusted as needed. For example, it may be appropriate to increase the current density of the anodic etching current to compensate for relatively large titanium substrates 10 due to their relatively large surface areas. Thus, an increased current density of the anodic etching current may be used to ensure that an adequate degree of oxide removal is achieved across the outer surface 12 of the titanium substrate 10. In one example, the establishing (block 246) of the anodic etching current may include establishing an anodic etching current having a current density of at least about 2 amps per square foot. In another example, the establishing (block 246) of the anodic etching current may include establishing an anodic etching current having a current density of at least about 4 amps per square foot. In yet another example, the establishing (block 246) of the anodic etching current may include establishing an anodic etching current having a current density of at least about 6 amps per square foot.

The anodic etching current may be maintained for any suitable duration of time. It may take longer to remove the oxide layer 14 if, among other things, the oxide layer 14 is particularly thick and/or the titanium substrate 10 is particularly large. In one example, the establishing (block 246) of the anodic etching current includes establishing an anodic etching current through the titanium substrate 10 for at least about 150 seconds. In another example, the establishing (block 246) of the anodic etching current includes establishing an anodic etching current through the titanium substrate 10 for at least about 300 seconds. In yet another example, the establishing (block 246) of the anodic etching current includes establishing an anodic etching current through the titanium substrate 10 for at least about 450 seconds. The goal is to remove the Bielby layer and not affect part dimensions or modify (smooth out) the mechanically cleaned surface.

As shown in FIG. 5, method 230 can further include determining 247 the complexing agent content of anodic electrolyte solution 44, e.g., after immersing the titanium substrate in the anodic electrolyte solution 44.

Following block 230 but before block 260, the method 200 may include, at block 250, rinsing the titanium substrate 10 that has been etched (e.g., the etched titanium substrate 11) to minimize cross-contamination and remove lingering oxygen ions surrounding the etched titanium substrate 11. For example, the rinsing (block 250) may be performed using a solution that contains a low oxygen concentration to minimize oxide layer 14 reformation. In an example, the etched titanium substrate 11 may be rinsed with the activation solution 34 used in block 232. In an example, the etched titanium substrate 11 may be rinsed with “dirty water” (e.g., water containing foreign contaminants). In an example, the etched titanium substrate 11 may be rinsed with the cathodic electrolyte solution 62 used in block 260 (described below). In an example, the etched titanium substrate 11 may be rinsed with an aqueous solution having a pH between about 3 and about 5.

A cathodic protection current may be established through the etched titanium substrate 11 to convert the otherwise active outer surface 13 of the etched titanium substrate 11 into a passive site for the oxide formation reaction. By supplying free electrons to the etched titanium substrate 11 and distributing a negative charge across the outer surface 13, the cathodic protection current may thereby prevent negatively charged oxygen ions from bonding to the outer surface 13. The cathodic protection current may be maintained (e.g., cathodically held) for as long as needed in preparation for block 280, strike plating a bond promoter layer 16 onto the outer surface 13 of the etched titanium substrate 11. Thus, it is generally contemplated that block 260 may be performed before block 280, but that block 280 may be performed immediately thereafter.

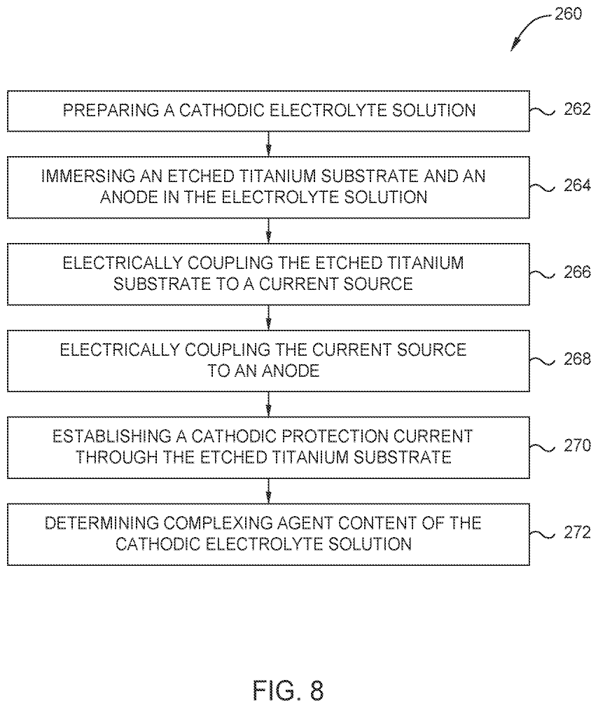

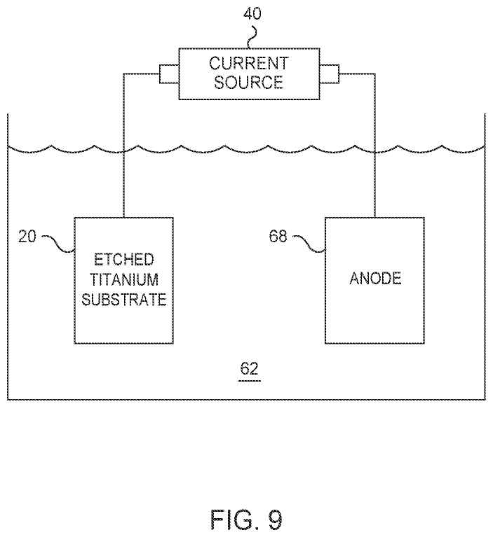

Referring to FIGS. 8 and 9, blocks 260 and 280 may be performed using an electrochemical cell similar to the configuration used for the anodic etching (block 238) (e.g., a standard two-electrode bath). A cathodic electrolyte solution 62 may first be prepared (block 262 (“preparing a cathodic electrolyte solution”)) so that a titanium substrate (e.g., the cathode) and a suitable anode 68 may be immersed (block 264 (“immersing an etched titanium substrate and an anode in the electrolyte solution”)) in it and electrically coupled (blocks 266 (“electrically coupling the etched titanium substrate to a current source”) and 268 (“electrically coupling the current source to an anode”)) to a current source. A cathodic protection current may then be established (block 270 (“establishing a cathodic protection current through the etched titanium substrate”)) for a duration of time before a strike current is applied (block 280) to deposit conductive metal ions in the cathodic electrolyte solution 62 onto the outer surface 13 of the etched titanium substrate 11, thereby forming the bond promoter layer 16.

Returning to FIG. 2, method 200 can further include determining 285 complexing agent content of an electrolyte solution, e.g., after strike plating the titanium substrate to plate a bond promoter layer onto the titanium substrate.

Additionally or alternatively, returning to FIG. 8, method 260 can include determining 272 complexing agent content of the cathodic electrolyte solution 62, e.g., after establishing the cathodic protection current 270 through the etched titanium substrate.

The cathodic electrolyte solution 62 may include, among other things, the conductive metal ions that will later be formed into the bond promoter layer 16 (following block 280). These conductive metal ions may include, for example, nickel ions, iron atoms, copper ions, and various other conductive metal ions that are suitable for strike plating. These conductive metal ions may be added to the activation solution 34 via any suitable source. For example, nickel sulfate hexahydrate (e.g., a nickel salt) may be added to the activation solution 34 to provide nickel ions. Further, the cathodic electrolyte solution 62 may also include various additives such as non-oxidizing acids, reducing agents to prevent oxide formation, and complexing agents. Referring specifically to complexing agents, in one example, the cathodic electrolyte solution 62 may include at least one of citric acid and sodium citrate. Reducing agents like ascorbic acid are used, for example, to prevent the ferrous iron from being oxidized to the ferric ion that is not platable.

The cathodic protection current may be applied at any suitable voltage (e.g., capable of preventing oxygen ions in the cathodic electrolyte solution 62 from binding to the outer surface 13 of the etched titanium substrate 11). The voltage may be predetermined prior to the performance of block 260, but may also be altered at any time if needed. In one example, the establishing (block 260) of the cathodic protection current includes applying a constant voltage of at least about 0 volts. In another example, the establishing (block 260) of the cathodic protection current includes applying a constant voltage of at least about 2 volts. In one example, the establishing (block 260) of the cathodic protection current includes applying a constant voltage of at least about 4 volts. The voltage is high enough to drive the oxide reaction but not so high that the hydrogen evolution reaction predominates.

The cathodic protection current may be maintained (e.g., “cathodically held”) for a duration of time until the strike current is applied. This duration of time, however, may be varied based on, among other things, the size and shape of the etched titanium substrate 11, and the time involved to remove the oxygen ions surrounding the outer surface 13 of the etched titanium substrate 11. In one example, the establishing (block 260) of the cathodic protection current may include establishing a cathodic protection current for at least about 15 seconds. In one example, the establishing (block 260) of the cathodic protection current may include establishing a cathodic protection (oxide reduction) current for at least about 120 seconds. In another example, the establishing (block 260) of the cathodic protection current may include establishing a cathodic protection current for at least about 480 seconds. In yet another example, the establishing (block 260) of the cathodic protection current may include establishing a cathodic protection current for about 30 seconds to about 600 seconds.

Both the duration and current density of the strike current may be controlled to deposit varying quantities of conductive metal ions on the outer surface 13 of the etched titanium substrate 11. By increasing the current density, the density of conductive metal ions across the outer surface 13 may increase as well. Accordingly, increasing the current density may be employed as a way to form thicker bond promoter layers 16 that cover more of the outer surface 13. In one example, the strike plating (block 280) may include applying a strike current to the etched titanium substrate 11, the strike current having a current density of at least about 50 amps per square foot. In another example, the strike plating (block 280) may include applying a strike current to the etched titanium substrate 11, the strike current having a current density of at least about 70 amps per square foot.

Like the anodic etching current and the cathodic protection (oxide reduction) current, the duration of time that strike current is applied may be varied as needed. However, it is generally contemplated that consideration should be given to the desired physical dimensions of the bond promoter layer 16. The longer the strike current is applied, the greater the quantity of conductive metal ions is deposited. In one example, the strike plating (block 280) may include applying a strike current for at least about 120 seconds. In another example, the strike plating (block 180) may include applying a strike current for at least about 240 seconds.

The bond promoter layer 16 on the outer surface 13 of the etched titanium substrate 11 provides the etched titanium substrate 11 with a conductive surface upon which the metallic material 18 may be plated. The strike plating (block 280) may thus, in effect, render the outer surface 13 of the etched titanium substrate 11 active to the metallic metal, and thereby facilitate titanium-substrate-to-plating adherence. Further, the bond promoter layer 16 may also be impermeable to oxygen, thereby “locking in” the whatever remains of the oxide layer 14 (if any) and preventing any additional oxygen ions from binding to the outer surface 13 of the etched titanium substrate 11.

After having been formed, the method 200 includes plating (block 290) a metallic material 18 onto the bond promoter layer 16. The metallic material 18 may cover at least a portion (if not most) of the outer surface 13 of the etched titanium substrate 11, thereby yielding a plated structure 20.

Various metallic materials 18 may be plated on the etched titanium substrate 11. As one example (e.g., for mechanical fastener applications), the metallic material 18 can be an electrically conductive and lubricious material, such as an electrically conductive and lubricious material that includes indium and/or tin. As another example (e.g., for corrosion protection), the metallic material 18 can be a sacrificial material, such as a sacrificial material that includes cadmium, zinc, and/or nickel. As another example (e.g., for heat reflecting applications), the metallic material 18 can be a high reflectivity material, such as a high reflectivity material that includes aluminum and/or gold. As another example (e.g., for sliding applications, such as pistons and actuators), the metallic material 18 can be a wear-resistant material, such as a wear-resistant material that includes chromium and nickel (e.g., electroless nickel).

When selecting a metallic material 18, consideration may be given to the compatibility of the metallic material 18 with the bond promoter layer 16. For example, if the bond promoter layer 16 includes nickel, a metallic material 18 that may be suitable for plating (block 290) may include indium. Those skilled in the art will appreciate, however, that various other combinations of metallic materials and bond promoter layer compositions may be employed without departing from the scope of the present disclosure.

The plating (block 290) may be performed using any suitable method. For example, electrodeposition, thin-film deposition, and/or sputter deposition may be employed to perform the plating (block 290), among other possible options. Further, the plating (block 290) may be performed such that the metallic material 18 is of a desired thickness and density. Accordingly, the physical dimensions of the metallic material 18 may vary.

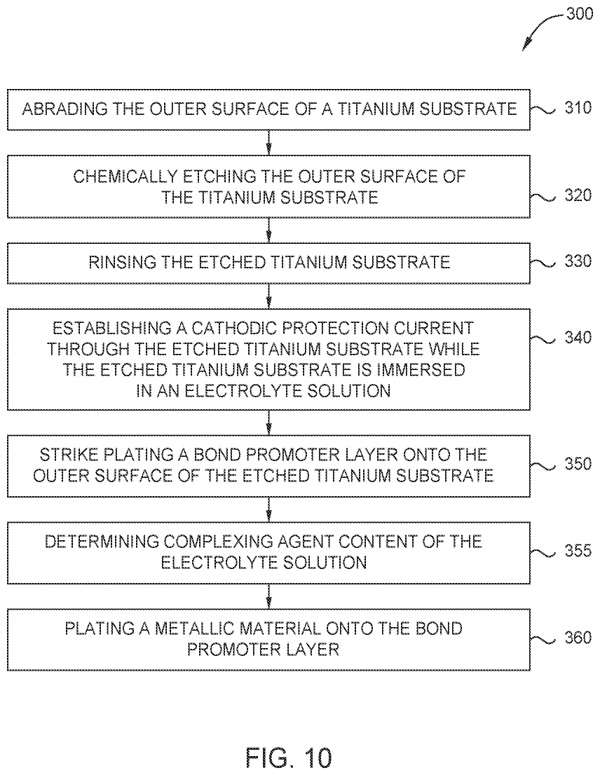

Referring to FIG. 10, the present disclosure provides another example of a method 300 for plating a metallic material 18 onto a titanium substrate 10, where the titanium substrate includes an outer surface 12 and an oxide layer 14 on the outer surface 12. The method 300 includes, at block 310, abrading the outer surface 12 of a titanium substrate 10 and, at block 320, chemically etching the outer surface 12 of the titanium substrate 10 to remove at least a portion of the oxide layer 14, thereby yielding an etched titanium substrate 11. The method 300 also includes, at block 330, rinsing the etched titanium substrate 11 and, at block 340, establishing a cathodic protection (oxide reduction) current through the etched titanium substrate 11 while the etched titanium substrate 11 is immersed in an electrolyte solution 62. The method 300 further includes, at block 350, strike plating a bond promoter layer 16 onto the outer surface 13 of the etched titanium substrate 11 after the establishing (block 340) of the cathodic protection current. The method 300 further includes, at block 355, includes determining complexing agent content of the electrolyte solution. The method 300 includes, at block 360, plating a metallic material 18 onto the bond promoter layer 16.

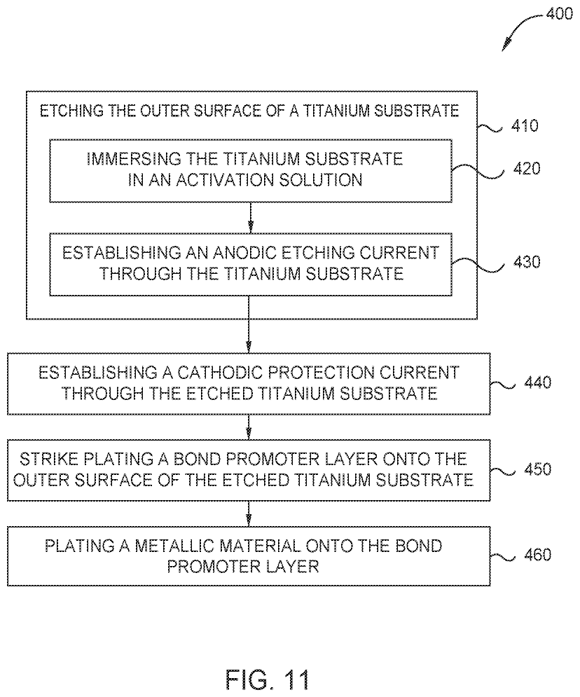

Referring to FIG. 11, the present disclosure provides another example of a method 400 for plating a metallic material 18 onto a titanium substrate 10, where the titanium substrate 10 includes an outer surface 12 and an oxide layer 14 on the outer surface 12. The method 400 includes, at block 410, etching the outer surface 12 of a titanium substrate 10 to yield an etched titanium substrate 11, the etching (block 410) includes, at block 420, immersing the titanium substrate 10 in an activation solution 34 and, at block 430, establishing an anodic etching current through the titanium substrate 10 while the titanium substrate 10 is immersed in the activation solution 34. The method 400 also includes, at block 440, establishing a cathodic protection current through the etched titanium substrate 11 while the etched titanium substrate 11 is immersed in a cathodic electrolyte solution 62. The method 400 further includes, at block 450, strike plating a bond promoter layer 16 onto the outer surface 13 of the etched titanium substrate 11 after the establishing (block 440) of the cathodic protection current, and, at block 460, plating a metallic material 18 onto the bond promoter layer 16.

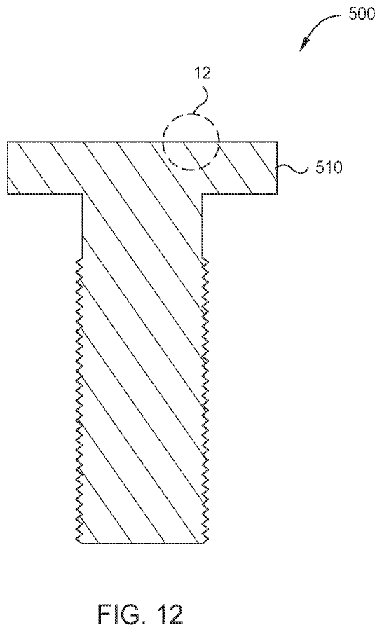

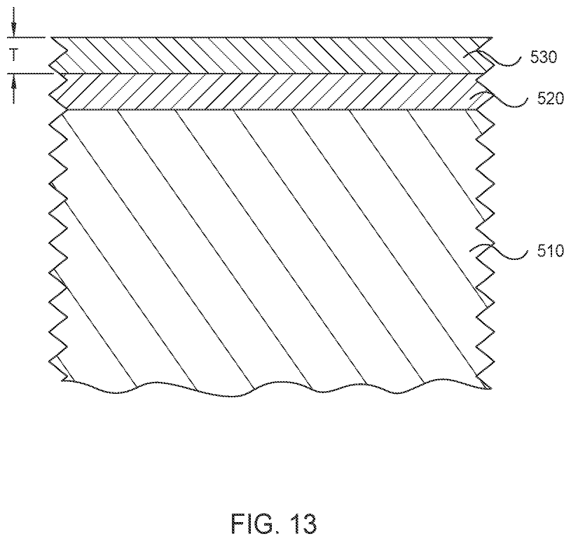

Referring to FIGS. 12 and 13, the present disclosure provides examples of an article 500 that may be manufactured using any of the previously disclosed methods (e.g., 100a, 100b, 200, 300, and 400). The article 500 includes a titanium body 510, a bond promoter layer 520 that includes, for example, a nickel-chromium alloy, and plating 530 (e.g., indium) on at least a portion of the titanium body 510. For example, the plating 530 has a thickness (T) ranging from about 0.2 mils to about 0.5 mils. As shown, the titanium body 510 may be a mechanical fastener, such as a bolt. However, those skilled in the art will appreciate that the titanium body 510 may be fabricated into a variety of shapes including, but not limited to, a tapered pin, a straight pin, a threaded lockbolt, a tapered sleeve bolt, a bushing, a tapered lock, a nut, a screw, and the like.

Mechanical fasteners are just one application of the disclosed methods for plating a metallic material onto a titanium substrate. For example, aircraft experience electromagnetic effects (EME) from a variety of sources, such as lightning strikes and precipitation static. Metallic aircraft structures are readily conductive and, therefore, are relatively less susceptible to electromagnetic effects. However, composite aircraft structures (e.g., carbon fiber reinforced thermoset and thermoplastic composite structures) do not readily conduct away the significant electrical currents and electromagnetic forces stemming from electromagnetic effects. Therefore, the disclosed methods can be used to direct the current into the mechanical fasteners, such as bolts, screws, rivets, blind fasteners and the like, that connect with metallic layers such as copper foil embedded within the wing.

Another application of the disclosed methods for plating a metallic material onto a titanium substrate is the use of sacrificial coatings like zinc-nickel to prevent dissimilar metal corrosion. Current practices to prevent corrosion when titanium is mated to aluminum is to prime the titanium surface and seal the joint against moisture intrusion. However, sealing is time-consuming and expensive for major subassemblies like a nacelle strut box. By plating the surface with a sacrificial coating, as is disclosed herein, the joint sealing process can be eliminated since the mating surfaces have a similar corrosion potential.

Yet another application of the disclosed methods for plating a metallic material onto a titanium substrate is plating titanium pneumatic ducts with a nickel coating that prevents damage due to phosphate ester fluid exposure. If the surface is bright (low emissivity) as well then it would prevent radiant heat from damaging aluminum and composite structure. The plating would replace an expensive gold coating that is a challenge to apply.

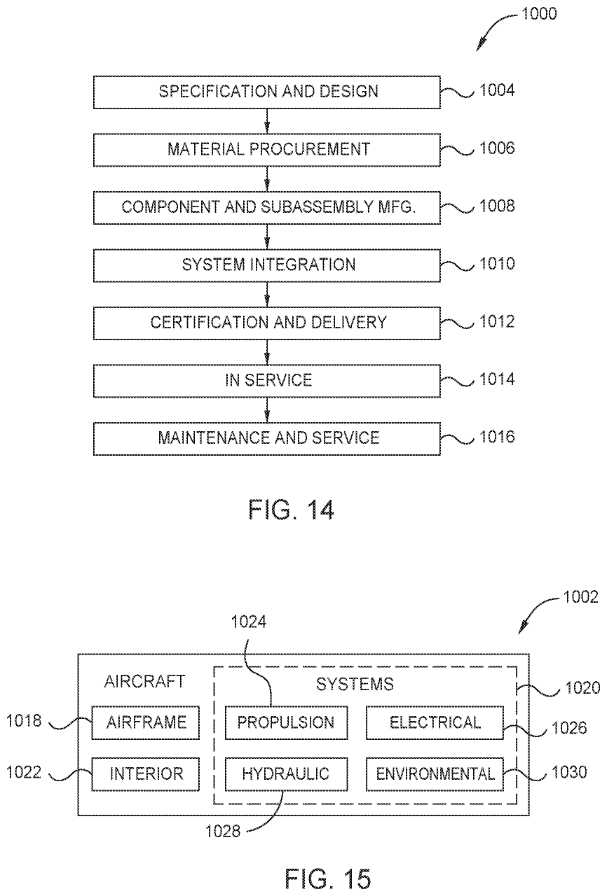

Examples of the disclosure may be described in the context of an aircraft manufacturing and service method 1000, as shown in FIG. 14, and an aircraft 1002, as shown in FIG. 15. During pre-production, the aircraft manufacturing and service method 1000 may include specification and design 1004 of the aircraft 1002 and material procurement 1006. During production, component/subassembly manufacturing 1008 and system integration 1010 of the aircraft 1002 takes place. Thereafter, the aircraft 1002 may go through certification and delivery 1012 in order to be placed in service 1014. While in service by a customer, the aircraft 1002 is scheduled for routine maintenance and service 1016, which may also include modification, reconfiguration, refurbishment and the like.

Each of the processes of method 1000 may be performed or carried out by a system integrator, a third party, and/or an operator (e.g., a customer). For the purposes of this description, a system integrator may include without limitation any number of aircraft manufacturers and major-system subcontractors; a third party may include without limitation any number of venders, subcontractors, and suppliers; and an operator may be an airline, leasing company, military entity, service organization, and so on.

As shown in FIG. 15, the aircraft 1002 produced by example method 1000 may include an airframe 1018 with a plurality of systems 1020 and an interior 1022. Examples of the plurality of systems 1020 may include one or more of a propulsion system 1024, an electrical system 1026, a hydraulic system 1028, and an environmental system 1030. Any number of other systems may be included.

The disclosed methods for plating a metallic material onto a titanium substrate may be employed during any one or more of the stages of the aircraft manufacturing and service method 1000. As one example, the disclosed methods for plating a metallic material onto a titanium substrate may be employed during material procurement 1006. As another example, components or subassemblies corresponding to component/subassembly manufacturing 1008, system integration 1010, and or maintenance and service 1016 may be fabricated or manufactured using methods of the present disclosure for plating a metallic material onto a titanium substrate. As another example, the airframe 1018 and the interior 1022 may be constructed using methods of the present disclosure for plating a metallic material onto a titanium substrate. Also, one or more apparatus examples, method examples, or a combination thereof may be utilized during component/subassembly manufacturing 1008 and/or system integration 1010, for example, by substantially expediting assembly of or reducing the cost of an aircraft 1002, such as the airframe 1018 and/or the interior 1022. Similarly, one or more of system examples, method examples, or a combination thereof may be utilized while the aircraft 1002 is in service, for example and without limitation, to maintenance and service 1016.

The disclosed methods for plating a metallic material onto a titanium substrate are described in the context of an aircraft; however, one of ordinary skill in the art will readily recognize that the disclosed methods may be utilized for a variety of applications. For example, the disclosed methods may be implemented in various types of wind turbines (e.g., components thereof) or various types of vehicles including, e.g., helicopters, passenger ships, automobiles.

Although various examples of the disclosed methods for plating a metallic material onto a titanium substrate have been shown and described, modifications may occur to those skilled in the art upon reading the specification. The present application includes such modifications and is limited only by the scope of the claims.

### Aspects

The present disclosure provides, among others, the following aspects, each of which may be considered as optionally including any alternate aspects.

### Clause 1. A Method, Comprising:

diluting a first solution with water to form a second solution, the first solution comprising a nickel source and a complexing agent;
introducing an indicator with the second solution;
titrating the second solution with a base to provide a color change of the second solution; and calculating a content of the complexing agent of the first solution.
   Clause 2. The method of Clause 1, wherein the indicator is represented by the formula:

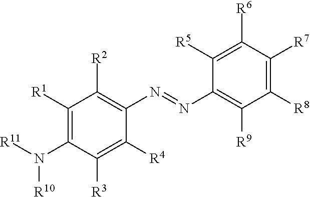

wherein:
each of R¹, R², R³, R⁴, R⁵, R⁶, R⁷, R⁸, and R⁹ is independently selected from the group consisting of hydrogen, alkyl, —SO₃H, and —CO₂H; and
each of R¹⁰ and R¹¹ is independently selected from the group consisting of hydrogen and alkyl.
   Clause 3. The method of Clauses 1 or 2, wherein the indicator is selected from the group consisting of 2,2-[4-(Dimethylamino)phenylazo]benzoic acid), 4-{[4-(dimethylamino)phenyl]diazenyl}benzene-1-sulfonic acid, derivative(s) thereof, salt(s) thereof, and combination(s) thereof.
   Clause 4. The method of any of Clauses 1 to 3, wherein the first solution has a pH of about 3.5 to about 4.
   Clause 5. The method of any of Clauses 1 to 4, wherein diluting is performed by diluting the first solution with the water at a volumetric ratio of water to first solution of about 15:1 to about 25:1.
   Clause 6. The method of any of Clauses 1 to 5, wherein the nickel source is selected from the group consisting of a nickel sulfate, a nickel acetate, a nickel chloride, and combination(s) thereof.
   Clause 7. The method of any of Clauses 1 to 6, wherein the complexing agent is an acid.
   Clause 8. The method of any of Clauses 1 to 7, wherein the acid is selected from the group consisting of a citric acid, an ascorbic acid, an oxalic acid, a bisulfite, and combination(s) thereof.
   Clause 9. The method of any of Clauses 1 to 8, wherein the base is selected from the group consisting of sodium hydroxide, potassium hydroxide, barium hydroxide, calcium hydroxide, and combination(s) thereof.
   Clause 10. The method of any of Clauses 1 to 9, wherein the base is a solution having a concentration of the base of about 0.1 M to about 1.0 M.
   Clause 11. The method of any of Clauses 1 to 10, wherein the content of the complexing agent is a concentration of the complexing agent and the concentration is calculated according to Equation 1:

$$ml of basic solution \times ( \frac{\# mol base}{1 L Solution} ) \times ( \frac{\# mol complexing agent}{\# mol base} ) \times ( \frac{1}{\# mL solution} ) \times ( \frac{g}{mol} complexing agent ) = g / L of complexing agent \qquad ( Eq . 1 )$$

Clause 12. The method of any of Clauses 1 to 11, further comprising:
plating a metallic material onto a titanium substrate, the titanium substrate comprising an outer surface and an oxide layer on the outer surface, wherein plating comprises:
   chemically etching the outer surface of the titanium substrate to remove at least a portion of the oxide layer forming an etched titanium substrate;
   establishing a cathodic protection current through the etched titanium substrate while the etched titanium substrate is immersed in the first solution;
   strike plating a bond promoter layer onto the outer surface of the etched titanium substrate after the establishing the cathodic protection current; and
   plating the metallic material onto the bond promoter layer.
      Clause 13. The method of any of Clauses 1 to 12, wherein diluting the first solution with water to form the second solution is performed after establishing the cathodic protection current through the etched titanium substrate.
      Clause 14. The method of any of Clauses 1 to 13, wherein diluting the first solution with water to form the second solution is performed after strike plating a bond promoter layer onto the outer surface of the etched titanium substrate.
      Clause 15. A method, comprising:
introducing an indicator with a first solution, the first solution comprising a nickel source and a complexing agent;
diluting with water the first solution comprising the indicator to form a second solution;
titrating the second solution with a base to provide a color change of the second solution; and
calculating a content of the complexing agent of the first solution.
   Clause 16. The method of Clause 15, wherein the indicator is selected from the group consisting of 2,2-[4-(Dimethylamino)phenylazo]benzoic acid), 4-{[4-(dimethylamino)phenyl]diazenyl}benzene-1-sulfonic acid, derivative(s) thereof, salt(s) thereof, and combination(s) thereof.
   Clause 17. The method of Clauses 15 or 16, wherein the first solution has a pH of about 3.5 to about 4.
   Clause 18. The method of any of Clauses 15 to 17, wherein diluting is performed by diluting the first solution with the water at a volumetric ratio of water to first solution of about 15:1 to about 25:1.
   Clause 19. The method of any of Clauses 15 to 18, wherein the nickel source is selected from the group consisting of a nickel sulfate, a nickel acetate, a nickel chloride, and combination(s) thereof.
   Clause 20. The method of any of Clauses 15 to 19, wherein the complexing agent is an acid.
   Clause 21. The method of any of Clauses 15 to 20, wherein the acid is selected from the group consisting of a citric acid, an ascorbic acid, an oxalic acid, a bisulfite, and combination(s) thereof.
   Clause 22. The method of any of Clauses 15 to 21, wherein the base is selected from the group consisting of sodium hydroxide, potassium hydroxide, barium hydroxide, calcium hydroxide, and combination(s) thereof.
   Clause 23. The method of any of Clauses 15 to 22, wherein the base is a solution having a concentration of the base of about 0.1 M to about 1.0 M.
   Clause 24. The method of any of Clauses 15 to 23, wherein the content of the complexing agent is a concentration of the complexing agent and the concentration is calculated according to Equation 1:

$$ml of basic solution \times ( \frac{\# mol base}{1 L Solution} ) \times ( \frac{\# mol complexing agent}{\# mol base} ) \times ( \frac{1}{\# mL solution} ) \times ( \frac{g}{mol} complexing agent ) = g / L of complexing agent \qquad ( Eq . 1 )$$

Clause 25. The method of any of Clauses 15 to 24, further comprising:
plating a metallic material onto a titanium substrate, the titanium substrate comprising an outer surface and an oxide layer on the outer surface, wherein plating comprises:
   chemically etching the outer surface of the titanium substrate to remove at least a portion of the oxide layer forming an etched titanium substrate;
   establishing a cathodic protection current through the etched titanium substrate while the etched titanium substrate is immersed in the first solution;
   strike plating a bond promoter layer onto the outer surface of the etched titanium substrate after the establishing the cathodic protection current; and
   plating the metallic material onto the bond promoter layer.
      Clause 26. The method of any of Clauses 15 to 25, wherein diluting the first solution with water to form the second solution is performed after establishing the cathodic protection current through the etched titanium substrate.
      Clause 27. The method of any of Clauses 15 to 26, wherein diluting the first solution with water to form the second solution is performed after strike plating a bond promoter layer onto the outer surface of the etched titanium substrate.

Overall, methods of the present disclosure provide determination of complexing agent content (e.g., weak acids or other acids) in colored activation solutions without a need for expensive, time-consuming chromatographic methods (e.g., chromatographic methods are merely optional), providing convenient determination of complexing agent content for industrial scale processes.

While the foregoing is directed to aspects of the present disclosure, other and further aspects of the disclosure may be devised without departing from the basic scope thereof, and the scope thereof is determined by the claims that follow.

What is claimed is:

1. A method, comprising:
diluting a first solution with water to form a second solution, the first solution comprising a nickel source and a complexing agent;
introducing an indicator with the second solution;
titrating the second solution with a base to provide a color change of the second solution; and
calculating a content of the complexing agent of the first solution.

2. The method of claim 1, wherein the indicator is represented by the formula: 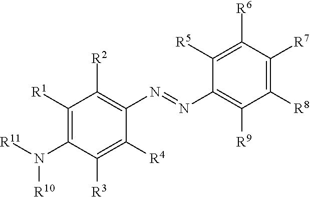
wherein:
each of R¹, R², R³, R⁴, R⁵, R⁶, R⁷, R⁸, and R⁹ is independently selected from the group consisting of hydrogen, alkyl, —SO₃H, and —CO₂H; and
each of R¹⁰ and R¹¹ is independently selected from the group consisting of hydrogen and alkyl.

3. The method of claim 1, wherein the indicator is selected from the group consisting of 2,2-[4-(Dimethylamino)phenylazo]benzoic acid), 4-{[4-(dimethylamino)phenyl]diazenyl}benzene-1-sulfonic acid, derivative(s) thereof, salt(s) thereof, and combination(s) thereof.

4. The method of claim 1, wherein the first solution has a pH of about 3.5 to about 4.

5. The method of claim 1, wherein diluting is performed by diluting the first solution with the water at a volumetric ratio of water to first solution of about 15:1 to about 25:1.

6. The method of claim 1, wherein the nickel source is selected from the group consisting of a nickel sulfate, a nickel acetate, a nickel chloride, and combination(s) thereof.

7. The method of claim 1, wherein the complexing agent is an acid.

8. The method of claim 7, wherein the acid is selected from the group consisting of a citric acid, an ascorbic acid, an oxalic acid, a bisulfite, and combination(s) thereof.

9. The method of claim 1, wherein the base is selected from the group consisting of sodium hydroxide, potassium hydroxide, barium hydroxide, calcium hydroxide, and combination(s) thereof.

10. The method of claim 9, wherein the base is a solution having a concentration of the base of about 0.1 M to about 1.0 M.

11. The method of claim 10, wherein the content of the complexing agent is a concentration of the complexing agent and the concentration is calculated according to Equation 1:
$$ml of basic solution \times ( \frac{\# mol base}{1 L Solution} ) \times ( \frac{\# mol complexing agent}{\# mol base} ) \times ( \frac{1}{\# mL solution} ) \times ( \frac{g}{mol} complexing agent ) = g / L of complexing agent \qquad ( Eq . 1 )$$

12. The method of claim 1, further comprising:
plating a metallic material onto a titanium substrate, the titanium substrate comprising an outer surface and an oxide layer on the outer surface, wherein plating comprises:
chemically etching the outer surface of the titanium substrate to remove at least a portion of the oxide layer forming an etched titanium substrate;
establishing a cathodic protection current through the etched titanium substrate while the etched titanium substrate is immersed in the first solution;
strike plating a bond promoter layer onto the outer surface of the etched titanium substrate after the establishing the cathodic protection current; and
plating the metallic material onto the bond promoter layer.

13. The method of claim 12, wherein diluting the first solution with water to form the second solution is performed after establishing the cathodic protection current through the etched titanium substrate.

14. The method of claim 12, wherein diluting the first solution with water to form the second solution is performed after strike plating a bond promoter layer onto the outer surface of the etched titanium substrate.

15. A method, comprising:
introducing an indicator with a first solution, the first solution comprising a nickel source and a complexing agent;
diluting with water the first solution comprising the indicator to form a second solution;
titrating the second solution with a base to provide a color change of the second solution; and
calculating a content of the complexing agent of the first solution.

16. The method of claim 15, wherein the indicator is selected from the group consisting of 2,2-[4-(Dimethylamino)phenylazo]benzoic acid), 4-{[4-(dimethylamino)phenyl]diazenyl}benzene-1-sulfonic acid, derivative(s) thereof, salt(s) thereof, and combination(s) thereof.

17. The method of claim 15, wherein the first solution has a pH of about 3.5 to about 4.

18. The method of claim 15, wherein diluting is performed by diluting the first solution with the water at a volumetric ratio of water to first solution of about 15:1 to about 25:1.

19. The method of claim 15, wherein the nickel source is selected from the group consisting of a nickel sulfate, a nickel acetate, a nickel chloride, and combination(s) thereof.

20. The method of claim 15, wherein the complexing agent is an acid.
